(19) United States
(12) Patent Application Publication
(10) Pub. No.: US 2010/0066802 A1
(43) Pub. Date: Mar. 18, 2010

(54) REMOTE COMMUNICATIONS DEVICE AND METHOD FOR FACILITATING MANUAL OPERATIONS

(76) Inventor: BRIAN DROSS, MT. PLEASANT, SC (US)

Correspondence Address: B. CRAIG KILLOUGH, P. O. DRAWER H, CHARLESTON, SC, 29402, US

(21) Appl. No.: 12/211,370

(22) Filed: Sep. 16, 2008

(51) Int. Cl. H04N 7/14

(52) U.S. Cl. 348/14.02; 348/E07.077

(57) ABSTRACT

A system and method of conveying visual images of a manual process to a remote location. A camera is aligned on an operator's head so that a line of view of the camera is essentially the same as a line of sight of the operator who is performing the manual operation. The visual image is procured by the camera and is transmitted to a remote location for a viewing by a consultant who is located at the remote location. Two way verbal communications are provided between the operator and the consultant. The manual process is viewed remotely in real time by the consultant, with the consultant viewing the manual process in essentially the same line of sight as the operator. The consultant instructs the operator in the performance of the manual process by the two way verbal communication.

### FIELD OF THE INVENTION

This invention relates to methods of visual and audible communications between persons while performing a manual operation.

### BACKGROUND OF THE INVENTION

It is common for operators to perform manual tasks while using their hands. Commonly, repair operations are performed by an operator who is skilled in making the repairs. It is necessary for the operator to have free use of his or her hands to hold tools for making the repair and/or to manipulate the object or objects being repaired.

Manual operations are used to perform a wide range of repairs. Repairs may be made on mechanical or electrical objects, or repairs may be on animals or humans, such as during surgical operations. Commonly, the person making the repairs may not have complete familiarity with the repair process to be performed. The person making the repair may also need assistance with tools used for a repair. For example, a technician attempting to repair a machine may be generally familiar with the type of machine, but may not be familiar with the specific machine, or may not be familiar with the repair process that needs to be performed. This may be particularly true where a new model or an improved model of a machine or tool is introduced, and the technician has not been trained on the new or improved machine, or the problem associated with a machine is seen for the first time.

Similarly, as new surgical processes are introduced, a surgeon will perform the surgical process for the first time. Also, as new surgical devices are presented to the market, the process for using a surgical device, or the process for installing the surgical device will be new to the surgeon.

In each of the above described cases the operator, such as a technician or surgeon, will be taught by a consultant or instructor who can offer assistance or advice in performing the manual operation with which the technician or surgeon is unfamiliar. Heretofore it has generally been necessary for an expert or consultant to be present on site with the operator so that the consultant or expert can view the operation as it is being performed, and offer advice, instruction and/or teaching to the operator.

However, physical presence of the consultant presents problems if the consultant is not available to travel to the location of the process to be performed. Delays in performing repairs may be occasioned until the consultant or expert can travel to the location. While instruction or advice may be given by telephone, the expert or consultant is limited if the expert or consultant is not looking at the manual operation as it is being performed by the operator. In an emergency situation, delays due to travel can be costly if a machine is down, or life threatening in the case of some surgical operations.

Further, travel costs are increasing. The value of the consultant's or expert's time, and the increasing cost of travel, inhibit the use of an on-site consultant.

There is a need for a system and process that will allow a consultant or expert to view the operation as it is being performed by the operator. The process should allow the consultant or expert to be at a remote location, which may be a substantial distance from the operator that is performing the operation. The system should allow the operator's hands to be free so that the operator can perform manual operation. The system and method should allow for two way communication between the consultant or expert and the operator.

### SUMMARY OF THE INVENTION

The present invention is a system and method of conveying visual images of a manual process to a remote location. The system and method include fitting a camera on an operator's head. The camera is aligned on the operator's head so that a line of view of the camera is essentially the same as a line of sight of the operator who is performing the manual operation. The visual image is procured by the camera and is transmitted to a remote location for a viewing by one or more consultant located remotely. Two way verbal communications are provided between the operator and the consultants. The manual process is viewed remotely in real time by the consultants, with the consultants viewing the manual process in essentially the same line of sight as the operator. The consultants instruct the operator in the performance of the manual process by the two way verbal communication.

### DESCRIPTION OF THE ILLUSTRATIONS

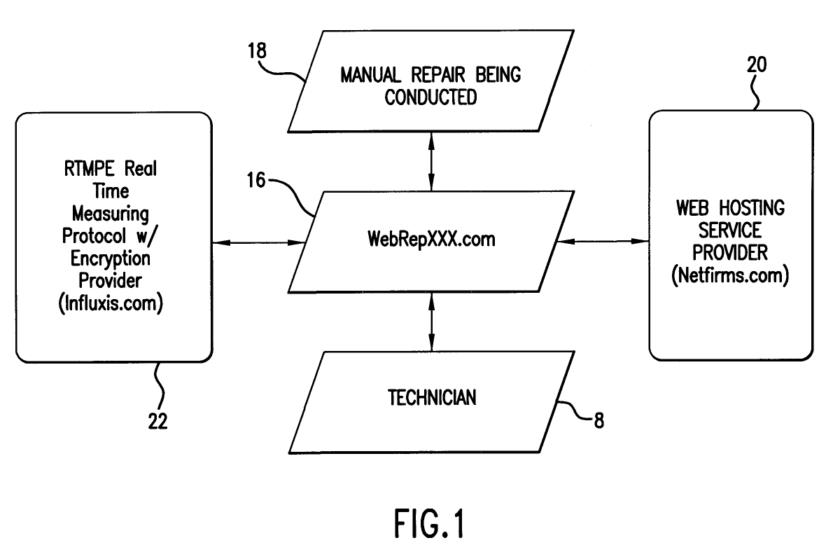

FIG. 1 demonstrates the flow of information according to one embodiment of the invention.

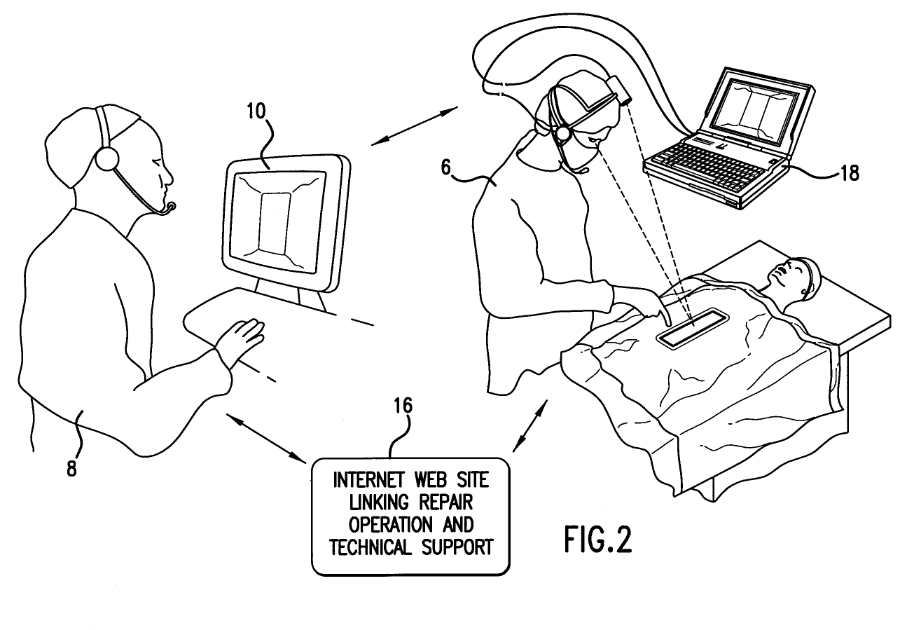

FIG. 2 demonstrates an interaction between participants using an embodiment of the invention.

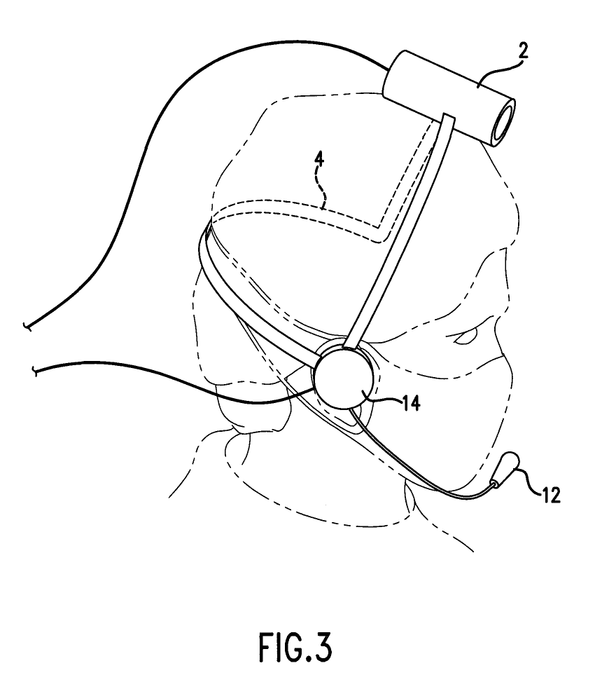

FIG. 3 demonstrates head gear worn by an operator with a video camera and audio receiving and transmission devices.

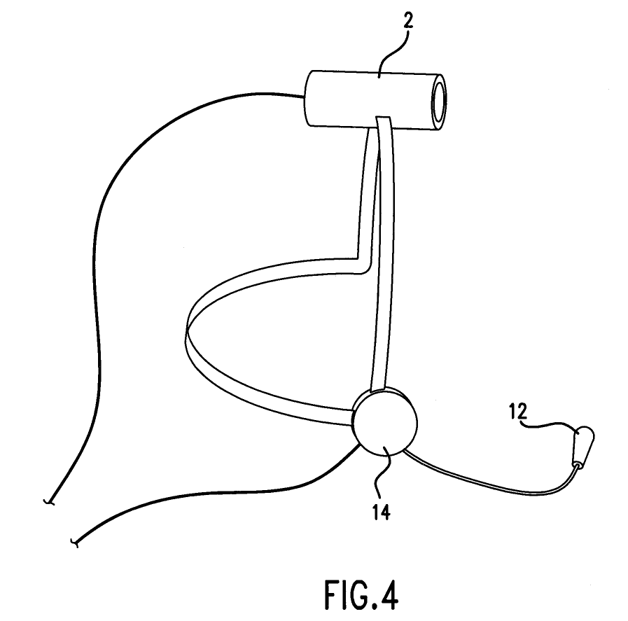

FIG. 4 demonstrates audio receiving and transmission devices for an operator.

### DETAILED DESCRIPTION OF THE PREFERRED EMBODIMENTS

In a preferred embodiment, a video camera 2 is fitted to a head of an operator. The video camera may be fitted by adjustable straps 4 that mount the video camera to the head of the video operator, or the video camera may be mounted to a hat that is worn by the operator. If a hat is used, the hat should fit tightly, and may incorporate adjustable banding so that the camera is securely fixed in position relative to the operator's head. The adjustable banding may comprise elastic, such as elastic bands.

The camera is adjusted so that the line of view of the camera is essentially the same as the line of sight of the operator 6. In this way, as visual images are transmitted to a consultant at a remote location, the consultant's view is essentially the same as the operator's view. Therefore, once the camera is positioned on the head of the operator so that the line of sight matches the line of sight of the operator, the camera should not move relative to the operator's head. As the operator's head moves, the camera will move with it, so that as the operator's line of sight changes, the view of the camera will change in the same manner.

The images captured by the camera may be still images or moving images such as Flash Media Real Time Measuring Protocol (RTMP) video images. Images may also be encrypted to ensure privacy (RTMPE) 22. Means for selectively capturing still images may be remotely controlled by the technician or consultant 8. The consultant may also remotely increase or decrease a zoom effect on the camera. The camera will capture visual images in real time and transfer the images in real time to the consultant. The consultant can control video capturing and if desired, play back “instant replay” of the images or video.

Remote transfer of the visual images may take place by communication devices, such as telephone lines, or radio communications, including cellular telephones. However, in a preferred embodiment, the visual images are transmitted from the camera to the remote user by the internet or a dedicated private virtual circuit (PVC). A computer may be present at the site 18 where the repair is performed, and transmitted by the internet to a computer display that is viewed by the consultant.

Video images 10 are received by the consultant or consultants at one or more remote locations. The remote locations may be in close proximity to the operator, and may be in a different room for various considerations. These considerations range from extreme cleanliness of the operator's location, such as a surgical suite or a clean room, or due to the operation taking place in a hazardous environment, such as an environment where nuclear or toxic materials are present, or where an explosion is possible. The operator receives the visual images over a video display, which may be a video monitor, including a computer screen. The consultant at the remote location visualizes the operation in substantially the same line of sight as the operator who is performing the operation. On the other hand, the consultant(s) may be remotely located at a substantial distance from the operator.

Two way audio communications are also provided between the operator and the remotely located consultant. Two way communications may be provided by telephone, radio, including cellular telephone. However, in a preferred embodiment, the two way communications are provided by internet communication, such as voice over internet protocol (VOIP).

As the operator performs the operation, the operator can question the consultant regarding the operation. The consultant can instruct the operator, so that the expertise of the consultant is conveyed to the operator performing the operation as the operator performs the repair process.

Two way voice communications may be transmitted using a two way head set worn by the operator that has both a microphone 12 and speaker 14. Alternatively, the speaker may be mounted remotely so that the operator can hear the sound, and one or both ears are not covered by a head set speaker. It is preferred, however, that the head set, as with the camera, not interfere with the manual operation. Neither the microphone, the speaker nor the camera associated with the operator should be held in the hands of the operator during the manual operation, so that the operator has hands that are free to perform the operation. The microphone may also be incorporated as a speaker phone feature of the camera to allow hands-free operation.

In one embodiment, a video display is also present where the operation is being performed. This video display is available for viewing to the operator. The video display may be controlled by the operator, and in one embodiment, is controlled by, or is also controlled by, the consultant from the remote location. This video displays instructional materials to the operator. The instructional material may also include audio output to the operator. In one embodiment, the instructional materials are available on a website 16. The consultant may refer the operator to the instructional materials available on the website, and the consultant may cause the instructional materials to be displayed on a video monitor, and the may review the instructional materials provided on the video display. Keeping in mind that the operator is still wearing the camera, the consultant and the operator will simultaneously view the video display that is present at the operator's location. The operator could, for example, point out features or issues regarding a machine, or in the case of surgery, an organ, to elicit further instruction by the consultant. The consultant may cause instructional materials to be displayed on the operator's video monitor and/or output through an audio device available to the operator. The instructional materials may be provided from internet sources or databases that are proprietary to, and/or available from, the website (demonstrated by WebRepXXX.com in FIG. 1 and website 16 of FIG. 2). This website will generally host the process of this embodiment of the invention, and may be operated by the consultant's company. The consultant's company may be the manufacturer or distributor of tools or equipment used in the process being performed by the operator.

Through the use of additional communications devices, multiple consultants may be engaged. The consultants may be at different locations from each other. In each case, the video images are transferred from the camera to each remote location, and two way communications are provided to and from each of the consultants and to and from the operator.

Both the camera, and the voice communications speaker worn by the operator may be wireless, so that the operator has unobstructed mobility for at least several meters in every direction.

The camera with two-way verbal communication may be mounted on an adjustable pole or stand. The stand may or may not have wheels. The stand may be adjusted vertically or horizontally to reflect the operator's perspective of a repair.

As demonstrated by FIG. 1, the technician or consultant 8 communicates with the location or site 18 where the manual repair is being performed. The communications of this embodiment are routed through a computer that may be provided by the technician's employer, and hosted by a web host 20.

What is claimed is:

1. A method of conveying visual images of a manual process to a remote location comprising the steps of:
a) fitting a camera to an operator's head, wherein said camera is aligned on said operator's head so that a line of view of said camera is essentially the same as a line of sight of said operator who performs the process;
b) transmitting a visual image procured by said camera to a remote location for viewing by a consultant who is located at said remote location;
c) providing two way verbal communication between said operator and said consultant who is located at said remote location;
d) said operator performing a manual process, wherein said manual process is viewed remotely in real time by said consultant, with said consultant remotely viewing said manual process in essentially the same line of sight as said operator;
wherein said consultant instructs said operator in the performance of the manual process by said two way verbal communication.

2. A method of conveying visual images of a manual process to a remote location as described in claim 1, wherein said camera is mounted to a hat.

3. A method of conveying visual images of a manual process to a remote location as described in claim 1, further comprising a two way headset worn by said operator.

4. A method of conveying visual images of a manual process to a remote location as described in claim 1, further comprising video images supplied to a location of said operator, wherein selection of said video images supplied to said location of said operator is remotely controlled by said consultant.

5. A method of conveying visual images of a manual process to a remote location as described in claim 1, wherein the manual process is a repair process.

6. A method of conveying visual images of a manual process to a remote location as described in claim 1, wherein the manual process is a surgical process.

7. A method of conveying visual images of a manual process to a remote location as described in claim 1, wherein both of said operator's hands are free for use in performing the manual process and neither said camera nor a device for providing two way verbal communication are held in the hands of said operator while said operator is performing the manual process

8. A method of conveying visual images of manual processes to a remote location as described in claim 1, wherein said visual images are transmitted by radio communications.

9. A method of conveying visual images of manual processes to a remote location as described in claim 1, wherein said visual images are transmitted by Internet communications.

10. A method of conveying visual images of manual processes to a remote location as described in claim 1, wherein said visual images and said two way verbal communications are transmitted by Internet communications.

11. A method of conveying visual images of manual processes to a remote location as described in claim 4, wherein said video images supplied to said location of said operator are displayed from an Internet website.
